(19) United States
(12) Patent Application Publication
(10) Pub. No.: US 2026/0267431 A1
(43) Pub. Date: Sep. 10, 2026

(54) ELECTRONIC DEVICE, INTERFACE SYSTEM INCLUDING THE SAME, AND METHOD FOR DRIVING ELECTRONIC DEVICE

(71) Applicant: Samsung Display Co., Ltd., Yongin-Si (KR)

(72) Inventors: KEUMDONG JUNG, Yongin-si (KR); JANGHUI KIM, Yongin-si (KR); YONGSUB SO, Yongin-si (KR)

(21) Appl. No.: 19/405,880

(22) Filed: Dec. 2, 2025

(30) Foreign Application Priority Data
Mar. 10, 2025 (KR) 10-2025-0030720

(51) Int. Cl. G06F 3/041

(52) U.S. Cl. CPC G06F 3/0416; G06F 3/0412

(57) ABSTRACT

An electronic device may include a sensor layer including a plurality of electrodes, a sensor driver outputting a signal to N electrodes of the plurality of electrodes, and a main driver controlling an operation of the sensor driver. The sensor driver is configured to during a first period, output a first signal to the sensor layer for dividing the N electrodes into a plurality of blocks, and during a second period different from the first period, output a second signal to the sensor layer for dividing electrodes in the plurality of blocks among the N electrodes.

### CROSS-REFERENCE TO RELATED APPLICATIONS

This U.S. non-provisional patent application claims priority under 35 U.S.C. § 119 of Korean Patent Application No. 10-2025-0030720, filed on Mar. 10, 2025, the entire contents of which are hereby incorporated by reference.

### BACKGROUND

This present disclosure herein relates to an electronic device, an interface system including the same, and an electronic device driving method.

Multimedia electronic devices, such as televisions, cell phones, tablet computers, notebooks, navigations, gaming devices, and the like, include display devices for displaying images. In addition to a general input method such as a button, a keyboard, and a mouse, electronic devices may include a sensor layer (or an input sensor) capable of providing a touch-based input method that allows a user to input information or commands easily and intuitively. The sensor layer may sense a touch or pressure by the user.

### SUMMARY

According to the present disclosure, an electronic device with high operation speed and reduced power consumption, an interface system including the same, and an electronic device driving method are provided.

According to an embodiment of the present disclosure, an electronic device may include a sensor layer including a plurality of electrodes; a sensor driver outputting a signal to N electrodes of the plurality of electrodes, N is an integer equal to or greater than 2; and a main driver controlling an operation of the sensor driver, wherein the sensor driver may be configured to during a first period, output a first signal to the sensor layer for distinguishing the N electrodes into a plurality of blocks; and during a second period different from the first period, output a second signal to the sensor layer for distinguishing electrodes in the plurality of blocks among the N electrodes.

In an embodiment, each of the plurality of blocks may include two or more electrodes among the N electrodes.

In an embodiment, the sensor driver may be configured to generate the first signal and the second signal using a code being based on a first matrix and a second matrix having sizes smaller than a reference matrix, respectively, the reference matrix including rows and columns being equal to or greater than N, and being powers of 2.

In an embodiment, the number of the rows of the reference matrix may correspond to a product of a number of rows of the first matrix and a number of rows of the second matrix.

In an embodiment, codes corresponding to each of first signals provided to electrodes included in one block among the plurality of blocks during the first period may be values of a first row of the first matrix, and codes corresponding to each of first signals provided to electrodes included in another block of the plurality of blocks during the first period may be values of a second row of the first matrix.

In an embodiment, a number of rows of the second matrix may be equal to or greater than a number of electrodes included one block among the plurality of blocks.

In an embodiment, codes corresponding to first signals provided to electrodes included in one block of the plurality of blocks during the first period may be a same code as each other.

In an embodiment, codes corresponding to second signals provided to electrodes included in one block of the plurality of blocks during the second period may be different from each other.

In an embodiment, the plurality of electrodes may include a plurality of first electrodes and a plurality of second electrodes intersecting with the plurality of first electrodes, and the sensor driver is configured to output signals to the plurality of first electrodes and the plurality of second electrodes during one frame.

In an embodiment, the one frame includes a first sub-frame and a second sub-frame consecutive to the first sub-frame, the sensor driver is configured to: during the first sub-frame, output the first signal and the second signal to at least a portion of the plurality of first electrodes, and during the second sub-frame, output the first signal and the second signal to at least a portion of the plurality of second electrodes.

In an embodiment, a length of the first period in which the first signal is output may be equal to or shorter than a length of the second period in which the second signal is output.

In an embodiment, the sensor driver may output a third signal for distinguishing the plurality of blocks during a third period different from the first period and the second period, and the plurality of blocks is configured to be distinguished by a combination of the first signal and the third signal.

In an embodiment, a length of the first period in which the first signal is output may be equal to or shorter than a length of the second period in which the second signal is output, and a length of the third period in which the third signal is output is equal to or shorter than a length of the first period.

In an embodiment, the main driver may receive an output signal including position information generated based on the signal provided by the sensor layer from an external object.

According to an embodiment of the present disclosure, a method for driving an electronic device may include determining a number of a plurality of sub-frames included in one frame; determining N, where N is an integer equal to or greater than 2, that is a number of channels to be simultaneously encoded in one sub-frame of the plurality of sub-frames; determining K less than N, where K is an integer equal to or greater than 1, and dividing each of the plurality of sub-frames into two or more; receiving K orthogonal vectors to be encoded in the channels; iteratively disposing the K orthogonal vectors to the channels; distinguishing the channels into a plurality of blocks, and disposing an identifier for uniquely identifying each of the plurality of blocks; and outputting a signal generated with a code including the identifier and the K orthogonal vectors.

In an embodiment, each of the plurality of blocks may include K or fewer channels of the channels, and a same identifier may be disposed for the channels included in one of the plurality of blocks.

In an embodiment, values of the K orthogonal vectors may be different from each other.

According to an embodiment of the present disclosure, an interface system may include a display panel including a display layer for displaying an image and a sensor layer including a plurality of electrodes; a display driver driving the display layer; a sensor driver outputting a signal to N electrodes of the plurality of electrodes, where N is an integer equal to or greater than 2; a main driver controlling operations of the display driver and the sensor driver; and an object receiving a signal from the sensor layer and outputting an output signal including position information to the main driver based on the signal, the sensor driver may be configured to output a first signal to the sensor layer for distinguishing the N electrodes into a plurality of blocks during a first period, and output a second signal to the sensor layer for distinguishing electrodes included in the plurality of blocks among the N electrodes during a second period different from the first period.

In an embodiment, the output signal may be configured to be transmitted from the object to the main driver via a near field communication.

In an embodiment, the sensor driver may be configured to generate the first signal and the second signal using a code being based on a first matrix and a second matrix having sizes smaller than a reference matrix, respectively, the reference matrix including rows and columns being equal to or greater than N, and being powers of 2, and a number of the rows of the reference matrix may correspond to a product of a number of rows in the first matrix and a number of rows in the second matrix, codes corresponding to first signals provided to electrodes included in one of the plurality of blocks during the first period may be the same as each other, and codes corresponding to second signals provided to electrodes included in the one of the plurality of blocks during the second interval may be different from each other.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a block diagram of an electronic device, according to an embodiment of the present disclosure.

FIG. 2 illustrates electronic devices, according to various embodiments of the present disclosure.

FIG. 3A is a usage state diagram of an electronic device, according to an embodiment of the present disclosure.

FIG. 3B is a usage state diagram of an electronic device, according to an embodiment of the present disclosure.

FIG. 4 is a schematic cross-sectional diagram of a display panel, according to an embodiment of the present disclosure.

FIG. 5 is a diagram for describing operations of an electronic device and an object, according to an embodiment of the present disclosure.

FIG. 6 is a flowchart illustrating an operation of an interface system, according to an embodiment of the present disclosure.

FIG. 7A is a block diagram of a sensor layer and a sensor driver, according to an embodiment of the present disclosure.

FIG. 7B is a diagram illustrating an interface system, according to an embodiment of of the present disclosure.

FIG. 8 is a diagram illustrating an interface system, according to an embodiment of the present disclosure.

FIG. 9A illustrates a digital code, according to an embodiment of the present disclosure.

FIG. 9B is a waveform diagram showing the signal, according to the digital code shown in FIG. 9A.

FIG. 10 is a diagram describing a weight coefficient determined between first electrodes and an object, according to an embodiment of the present disclosure.

FIG. 11A illustrates voltage waveforms of signals received at an object.

FIG. 11B shows the voltage waveform of superimposed signal, in which signals are superimposed.

FIG. 12 is a flowchart illustrating an operation for dividing a digital code, serving as the basis of a signal, into two or more groups, according to an embodiment of the present disclosure.

FIG. 13A is a diagram illustrating a signal received by the sensor layer in a first sub-frame, according to an embodiment of the present disclosure.

FIG. 13B is a diagram illustrating a signal received by the sensor layer in a second sub-frame, according to an embodiment of the present disclosure.

FIG. 13C is a diagram illustrating a signal received by the sensor layer in a third sub-frame, according to an embodiment of the present disclosure.

FIG. 14 is a table illustrating a determination example of an order of a first matrix and an order of a second matrix for each case, according to an embodiment of the present disclosure

FIG. 15A illustrates a 4×4 matrix, according to an embodiment of the present disclosure.

FIG. 15B illustrates an 8×8 matrix, according to an embodiment of the present disclosure.

FIG. 16A is a diagram illustrating a code corresponding to a signal received by a sensor layer in one sub-frame, according to an embodiment of the present disclosure.

FIG. 16B is a diagram illustrating a code corresponding to a signal received by a sensor layer in one sub-frame, according to an embodiment of the present disclosure.

FIG. 16C is a diagram illustrating a code corresponding to a signal received by a sensor layer in one sub-frame, according to an embodiment of the present disclosure.

FIG. 17 is a diagram illustrating a code corresponding to a signal received by a sensor layer in one sub-frame, according to an embodiment of the present disclosure.

FIG. 18 is a table showing an example of determining an order of a first matrix, an order of a second matrix, and an order of a third matrix for each case, according to an embodiment of the present disclosure.

FIG. 19 illustrates a 2×2 matrix, according to an embodiment of the present disclosure.

FIG. 20 is a diagram illustrating a code corresponding to a signal received by a sensor layer in one sub-frame, according to an embodiment of the present disclosure.

### DETAILED DESCRIPTION

Herein, when a component (or region, layer, portion, etc.) is referred to as being “on,” “connected to,” or “coupled to” another component, it means that it can be directly disposed/connected/coupled to the other component or a third component may be disposed therebetween.

Like numbers refer to like components. In addition, in the drawings, the thicknesses, proportions, and dimensions of the components are exaggerated for effective description of the technical content.

Although the terms first, second, etc. may be used to describe various elements, the elements should not be limited by the terms. The terms are only used for the purpose of distinguishing one component, part, region, layer or portion from another component, part, area, layer or portion. For example, a first component, a first part, a first region, a first layer or a first portion may be named a second component, a second part, a second region, a second layer or a second portion, and similarly a second component, second part, second region, second layer or second portion may also be named a first component, first part, first region, first layer or first portion, without departing from the scope of the present invention. The singular forms “a,” “an,” and “the” include plural referents unless the context clearly dictates otherwise.

In addition, terms such as “below”, “under”, “above”, “on top”, and the like are used to describe the associations of the components shown in the figures. The terms are described in relative terms with reference to the directions indicated in the figures.

It should be understood that terms such as “comprise” and “include” are intended to specify the presence of stated features, numbers, steps, operations, components, parts, or combinations thereof, but do not preclude the presence or addition of one or more other features, numbers, step, operations, components or combinations thereof.

The terms of “part” and “unit” mean a software component or a hardware component that performs a specific function. Hardware components may include, for example, field-programmable gate arrays (FPGAs) or application-specific integrated circuits (ASICs). A software component may refer to executable code or data used by executable code in an addressable storage medium. Software elements may thus be, for example, object-oriented software elements, class elements, and task elements, and may include processes, functions, attributes, procedures, subroutines, program code segments, drivers, firmware, microcodes, circuits, data, databases, data structures, tables, arrangements, or variables.

Unless otherwise defined, all terms (including technical and scientific terms) used herein have the same meaning as commonly understood by one of ordinary skill in the art to which this invention belongs. Furthermore, terms, such as those defined in commonly used dictionaries, should be interpreted as having a meaning that is consistent with their meaning in the context of the relevant art and should not be interpreted in a too idealized or overly formal sense unless expressly so defined herein.

Hereinafter, embodiments of the present invention will be described with reference to the drawings.

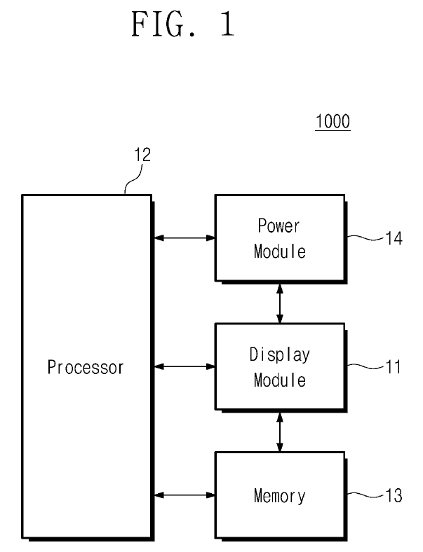

FIG. 1 is a block diagram of an electronic device 1000, according to an embodiment of the present disclosure.

Referring to FIG. 1, an electronic device 1000, according to an embodiment may include a display module 11, a processor 12, a memory 13, and a power module 14.

The display module 11 may display an image. The image may include a still image as well as a dynamic image. The processor 12 may include at least one of a central processing unit (CPU), an application processor (AP), a graphics processing unit (GPU), a communication processor (CP), an image signal processor (ISP), or a controller. The processor 12 may be configured to control an operation of the display module 11.

The memory 13 may store data information necessary for operation of the processor 12 or the display module 11. When the processor 12 executes the application stored in the memory 13, an image data signal and an input control signal may be transmitted to the display module 11, and the display module 11 may process the received signal to output the image information through the display screen.

The power module 14 may include a power supply module such as a power adapter or a battery device, and a power conversion module that converts power supplied by the power supply module to generate power required for operation of the electronic device 1000.

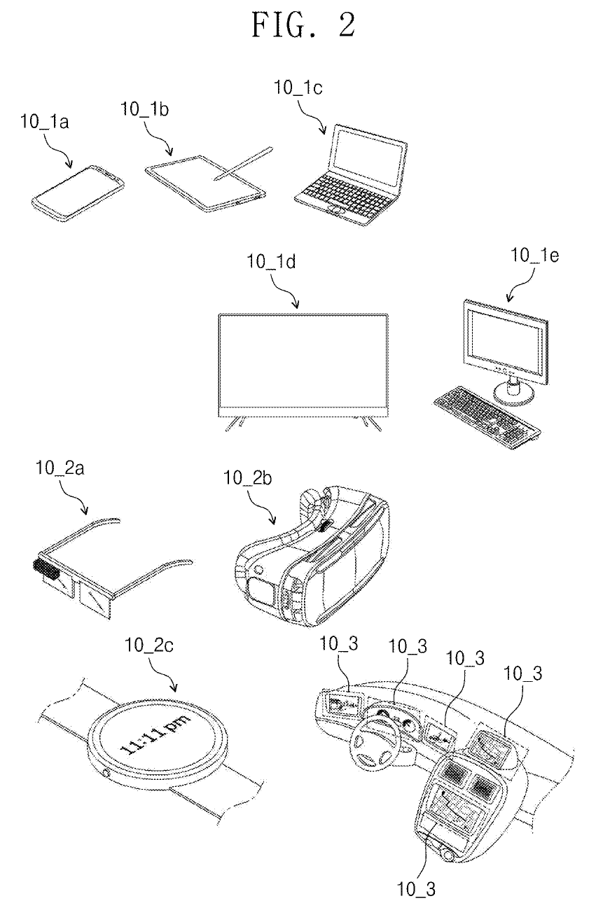

FIG. 2 illustrates electronic devices in accordance with various embodiments of the present disclosure.

Referring to FIG. 2, various electronic devices to which the display device, according to the embodiments is applied may include an electronic device for image display such as a smartphone 10_1a, a tablet PC 10_1b, a laptop 10_1c, a TV 10_1d, and a desk monitor 10_1e, a wearable electronic device including a display module such as smart glasses 10_2a, a head-mounted display 10_2b, and a smart watch 10_2c, as well as a vehicle electronic device 10_3 including a display module, such as a CID (Center Information Display) disposed on an instrument panel, a center fascia, and a dashboard of an automobile, a room mirror display, and the like.

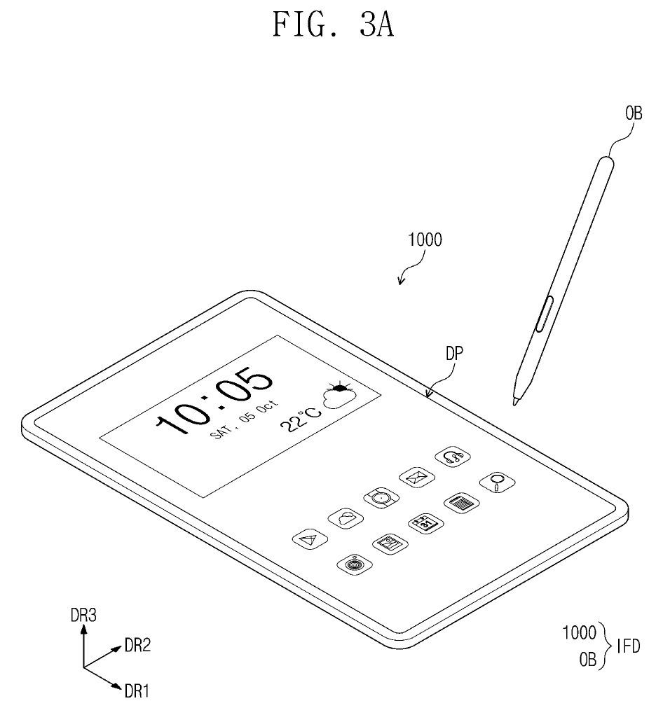

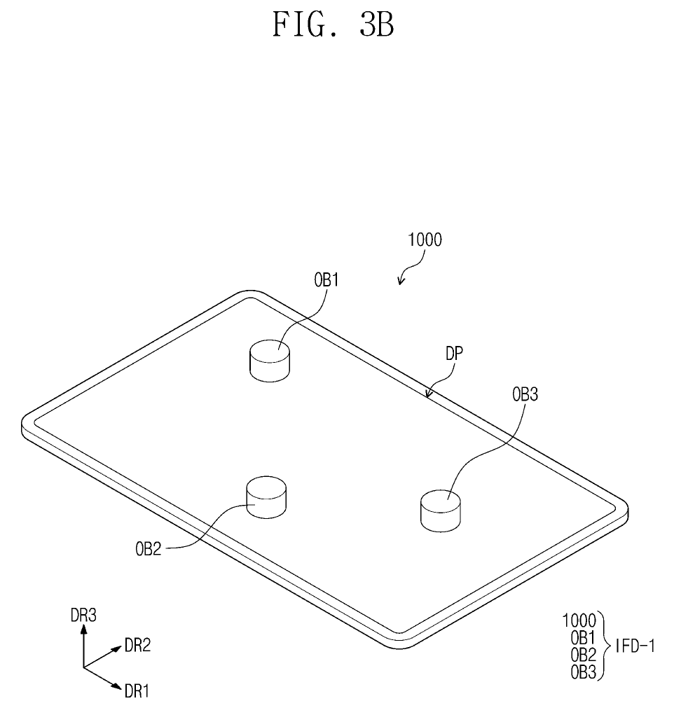

FIG. 3A is a usage state diagram of an electronic device 1000, according to an embodiment of the present disclosure. FIG. 3B is a usage state diagram of an electronic device 1000, according to an embodiment of the present disclosure.

Referring to FIGS. 3A and 3B, the electronic device 1000 may be a device that is activated, according to an electrical signal. For example, the electronic device 1000 may include a display panel DP. The display panel DP may display images through a display surface that is parallel to a first direction DR1 and a second direction DR2, and a thickness of the display panel DP may be defined in a third direction DR3 that intersects the first direction DR1 and the second direction DR2.

The display panel DP may display an image and sense an external input applied from the outside. The external input may be user's input. The user's input may include various forms of external inputs, such as a portion of the user's body, light, heat, or pressure. In an embodiment, the display panel DP may transmit a signal to objects OB, OB1, OB2, and OB3. The objects OB, OB1, OB2, and OB3 may be referred to as items, transceivers, things, peripheral devices, or the like.

In an embodiment of the present disclosure, the electronic device 1000 may communicate with the objects OB, OB1, OB2, and OB3. Each of the objects OB, OB1, OB2, and OB3 may receive a signal from the electronic device 1000 and decode the signal based on a determined protocol to restore position information of each of the objects OB, OB1, OB2, and OB3 in the electronic device 1000. The objects OB, OB1, OB2, and OB3 may transmit corresponding position information to the electronic device 1000.

Referring to FIG. 3A, the object OB may be a pen. The electronic device 1000 and the object OB interacting with (or communicating with) the electronic device 1000 may be referred to as an interface system IFD. Referring to FIG. 3B, the objects OB1, OB2, and OB3 may be peripheral devices capable of communicating with the electronic device 1000. The electronic device 1000 and the objects OB1, OB2, OB3 interacting with the electronic device 1000 may be referred to as an interface system IFD-1. The interface system IFD or IFD-1 may be referred to as an interface system, an interface set, an electronic device unit, an electronic device group, an electronic device set, or the like.

In an embodiment of the present disclosure, the objects OB1, OB2, and OB3 may be various items such as a communicable figure, a card, a toy, or a robot, and are not particularly limited thereto. In a case where the objects OB1, OB2, and OB3 are placed in the electronic device 1000, the objects OB1, OB2, and OB3 may transmit position information from/to each other.

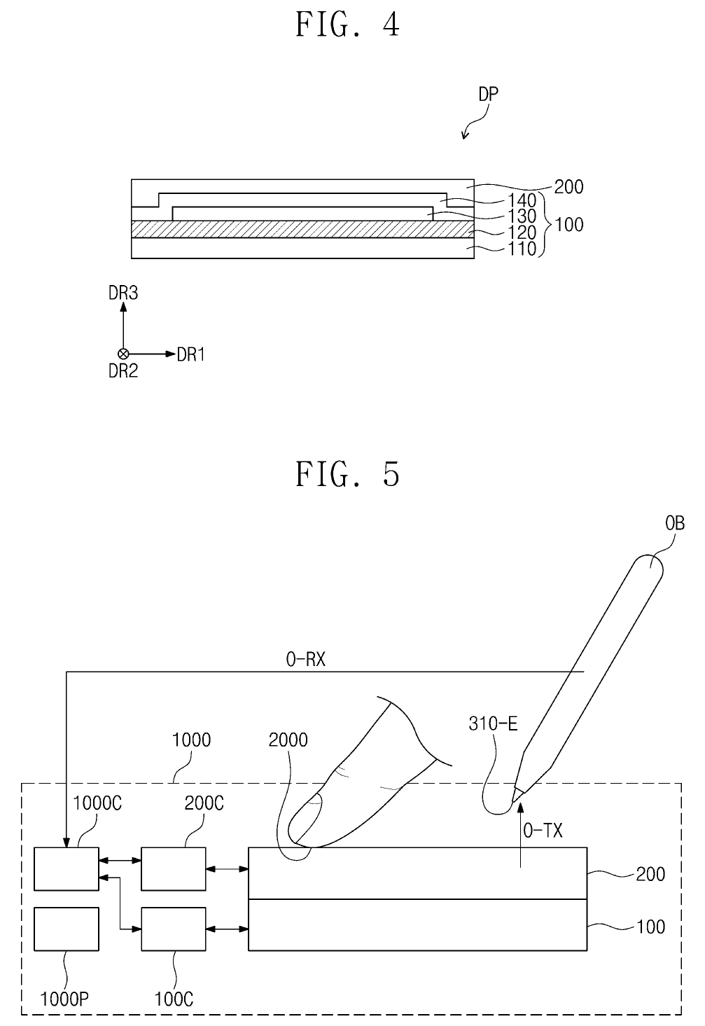

FIG. 4 is a schematic cross-sectional diagram of the display panel DP, according to an embodiment of the present disclosure.

Referring to FIG. 4, the display panel DP may include a display layer 100 and a sensor layer 200. An upper functional member may further be placed on the sensor layer 200. For example, the upper functional member may include at least one of an antireflection layer, a window, and a protective film.

The display layer 100 may be configured to substantially generate an image. The display layer 100 may be a light-emitting display layer, and for example, the display layer 100 may be an organic light-emitting display layer, an inorganic light-emitting layer, an organic- inorganic light-emitting layer, a quantum-dot display layer, a micro LED display layer, or a nano LED display layer.

The display layer 100 can include a base layer 110, a circuit layer 120, a light-emitting element layer 130, and an encapsulation layer 140.

The base layer 110 may be a member that provides a base surface on which the circuit layer 120 is disposed. The base layer 110 may have a multi-layer structure or a single-layer structure. The base layer 110 may be a glass substrate, a metal substrate, a silicon substrate, a polymer substrate, or the like, but is not particularly limited thereto.

The circuit layer 120 may be placed over the base layer 110. The circuit layer 120 may include an insulating layer, a semiconductor pattern, a conductive pattern, a signal line, and the like. An insulating layer, a semiconductor layer, and a conductive layer are formed on the base layer 110 by processing of coating, evaporation, or the like, and the insulating layer, the semiconductor layer, and the conductive layer may be selectively patterned through a plurality of photolithography processes.

The light-emitting element layer 130 may be placed on the circuit layer 120. The light-emitting element layer 130 may include a light-emitting element. For example, the light-emitting element layer 130 may include an organic light-emitting material, an inorganic light-emitting material, an organic-inorganic light-emitting material, a quantum dot, a quantum rod, a micro LED, or a nano LED.

The encapsulation layer 140 may be placed on the light-emitting element layer 130. The encapsulation layer 140 can protect the light-emitting element layer 130 from foreign matters such as moisture, oxygen, and dust particles.

The sensor layer 200 may be placed on the display layer 100. The sensor layer 200 may sense an external input applied from the outside. The sensor layer 200 may be an integrated sensor formed continuously during the manufacturing process of the display layer 100, or the sensor layer 200 may also be an external sensor attached to the display layer 100. The sensor layer 200 may be referred to as a sensor, an input sensing layer, an input sensing panel, an electronic device for sensing input coordinates, or the like.

According to an embodiment of the present disclosure, the sensor layer 200 may sense input by passive type input means such as a user's body. In an embodiment, the sensor layer 200 may transmit a signal to the objects OB, OB1, OB2, OB3 described in FIGS. 3A and 3B. A specific description thereof will be given later.

FIG. 5 is a diagram for describing operations of the electronic device 1000 and the object OB, according to an embodiment of the present disclosure.

Referring to FIG. 5, the electronic device 1000 may include a display layer 100, a sensor layer 200, a display driver 100C, a sensor driver 200C, a main driver 1000C, and a power circuit 1000P.

The main driver 1000C may control overall operation of the electronic device 1000. For example, the main driver 1000C may control operations of the display driver 100C and the sensor driver 200C. That is, the main driver 1000C may control operations of the display layer 100 and the sensor layer 200. The main driver 1000C may include at least one microprocessor, and may further include a graphics controller. The main driver 1000C may be referred to as a host, an application processor, a central processing unit, or a main processor. The main driver 1000C may correspond to the processor 12 described with reference to FIG. 1.

The display driver 100C may drive or control the display layer 100. The display driver 100C may receive the image data and a first control signal from the main driver 1000C. The first control signal may include various signals. For example, the first control signal may include an input vertical sync signal, an input horizontal sync signal, a main clock signal, a data enable signal, and the like.

The sensor driver 200C may drive or control the sensor layer 200. The sensor drive 200C may receive a second control signal from the main drive 1000C. The second control signal may comprise a clock signal of the sensor driver 200C. In addition, the second control signal may further include a mode determination signal for determining a driving mode of the sensor driver 200C and the sensor layer 200.

The sensor layer 200 may sense an external input 2000 applied from the outside, or transmit a signal O-TX to the object OB. For example, the sensor driver 200C and the sensor layer 200 may selectively operate in a first mode or a second mode. For example, the first mode may be a mode of sensing a touch input, e.g., input 2000. The second mode may be a mode of transmitting the signal O-TX to the object OB.

In the first mode, the sensor driver 200C may calculate coordinate information of an input based on a signal received from the sensor layer 200, and provide a coordinate signal having the coordinate information to the main driver 1000C. The main driver 1000C executes an operation corresponding to the user input based on the coordinate signal. For example, the main driver 1000C may operate the display driver 100C such that a new application image is displayed on the display layer 100.

In the second mode, the sensor driver 200C and the sensor layer 200 only transmit the signal O-TX, and the sensor driver 200C and the sensor layer 200 may not receive the output signal O-RX provided from the object OB. The output signal O-RX may include position information of the object OB generated based on the signal O-TX. For example, the output signal O-RX may include information about the position of a sensing electrode 310-E of the object OB within the sensor layer 200.

The output signal O-RX provided from the object OB may be output to the main driver 1000C. For example, the output signal O-RX may be provided to the main driver 1000C via a near field communication, for example, Bluetooth communication or Wi-Fi communication, or the like.

That is, the output signal O-RX output from the object OB is directly provided to the main driver 1000C without passing through the sensor layer 200. Thus, the output signal O-RX is not affected by noise caused in the sensor layer 200 by the display layer 100. Further, as the output signal O-RX is directly provided to the main driver 1000C, the speed may be improved compared to the case where the output signal is transmitted to the main driver 1000C through the sensor layer 200.

The power circuit 1000P may include a power management integrated circuit (PMIC). The power circuit 1000P may generate a plurality of driving voltages for driving the display layer 100, the sensor layer 200, the display driver 100C, and the sensor driver 200C. For example, the plurality of driving voltages may include, but are not particularly limited to, a high gate voltage, a low gate voltage, a first driving voltage, a second driving voltage, an initialization voltage, and the like.

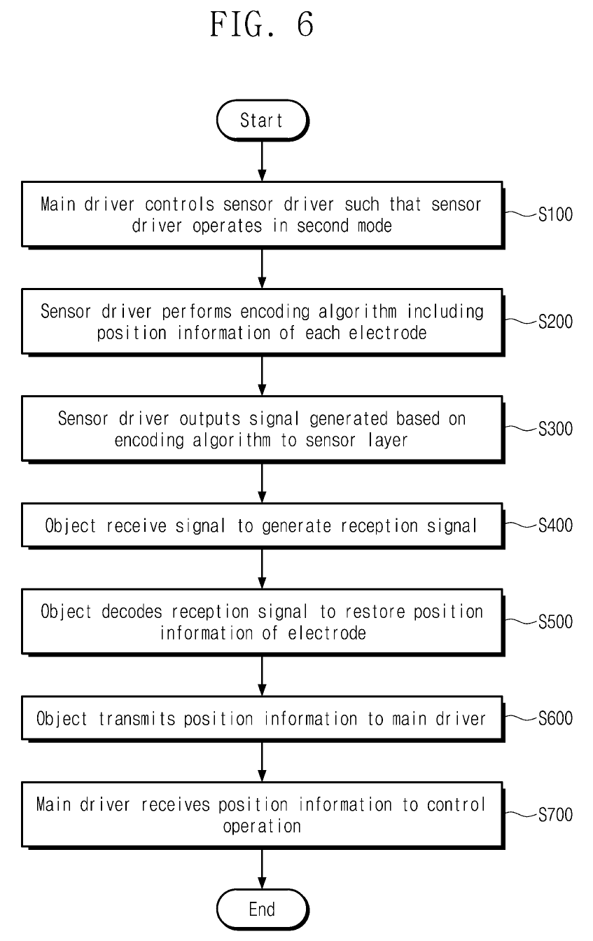

FIG. 6 is a flowchart illustrating the operation of an interface system (IFD, see FIG. 3A), according to an embodiment of the present disclosure.

Referring to FIGS. 5 and 6, the main driver 1000C may control the sensor driver 200C such that the sensor driver 200C operates in the second mode (S100).

The sensor driver 200C may perform an encoding algorithm including position information of each electrode (S200). The sensor driver 200C may output the signal O-TX generated based on the encoding algorithm to the sensor layer 200 (S300).

The object OB may receive the signal O-TX and generate a reception signal (S400). The object OB may decode the reception signal to recover the positional information of the electrode in the sensor layer 200 (S500). The object OB may transmit an output signal O-RX including the position information to the main driver 1000C (S600). The main driver 1000C may receive the output signal O-RX including the position information and control the operation of the display driver 100C or the sensor driver 200C (S700).

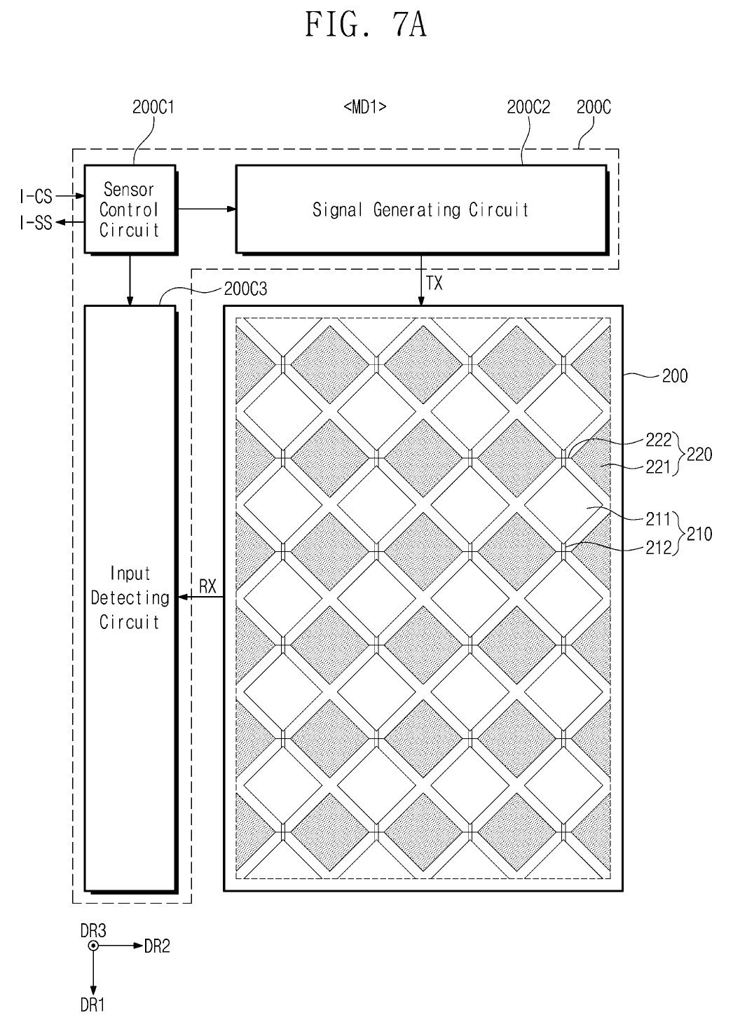

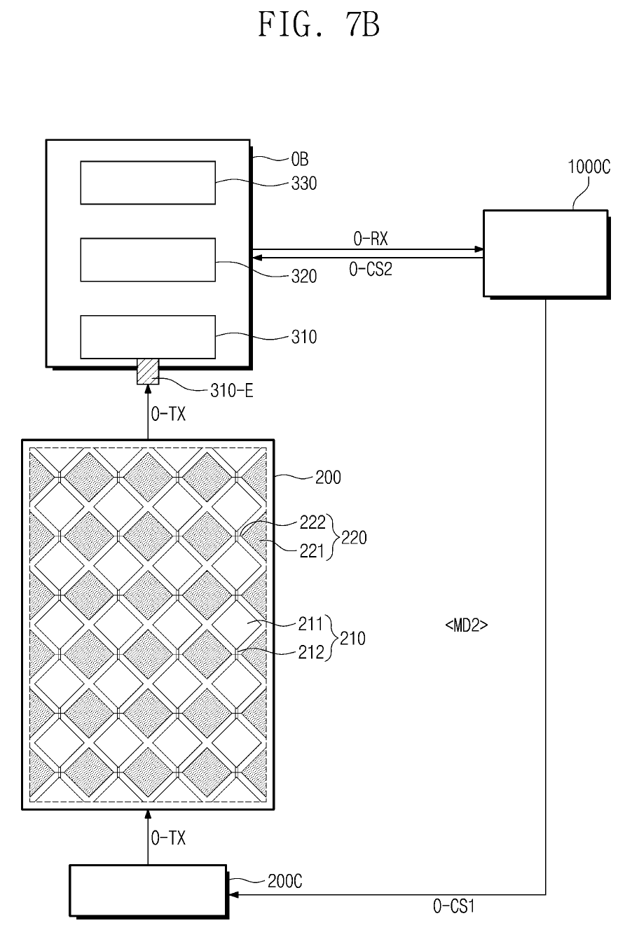

FIG. 7A is a diagram illustrating a sensor layer 200 and a sensor driver 200C, according to an embodiment of the present disclosure.

Referring to FIG. 7A, the sensor layer 200 may include a plurality of first electrodes 210 and a plurality of second electrodes 220. Each of the first electrodes 210 extends along the first direction DR1, and the first electrodes 210 may be spaced apart from each other in the second direction DR2. Each of the second electrodes 220 extends along the second direction DR2, and the second electrodes 220 may be spaced apart from each other in the first direction DR1. Each of the second electrodes 220 may intersect with the first electrodes 210. Although four first electrodes 210 and six second electrodes 220 are illustratively illustrated in FIG. 7A, this is merely an illustration of some configurations, and the sensor layer 200 may include a greater number of first and second electrodes 210, 220 than the illustrated first electrodes 210 and second electrodes 220.

Each of the first electrodes 210 may include a sensing pattern 211 and a connection pattern 212. Two sensing patterns 211 adjacent to each other may be electrically connected to each other by two connection patterns 212, but the present disclosure is not limited thereto. The sensing pattern 211 and the connection patterns 212 may be disposed on different layers, respectively.

Each of the second electrodes 220 may include a first portion 221 and a second portion 222. The first portion 221 and the second portion 222 have integral shapes with each other, and may be placed on the same layer. For example, the first portion 221 and the second portion 222 may be placed on the same layer as the sensing pattern 211. The two connection patterns 212 may be insulated from the second portion 222 and intersect with the second portion 222.

The sensor driver 200C may be electrically connected to the sensor layer 200 by implementing the sensor driver 200C as an integrated circuit (IC) to directly mount on a predetermined area of the sensor layer 200 or mount on a separate printed circuit board in a chip on film (COF) manner.

The sensor drive unit 200C may include a sensor control circuit 200C1, a signal generating circuit 200C2, and an input detecting circuit 200C3. The sensor control circuit 200C1 may control operations of the signal generating circuit 200C2 and the input detecting circuit 200C3 based on a control signal I-CS.

The sensor driver 200C may receive the control signal I-CS from the main driver 1000C (see FIG. 5).

In the first mode MD1, the signal generating circuit 200C2 may output transmission signals TX to the first electrodes 210 of the sensor layer 200. The input detecting circuit 200C3 may receive sensing signals RX from the sensor layer 200. For example, the input detecting circuit 200C3 may receive the sensing signals RX from the second electrodes 220. In one embodiment, the signal generating circuit 200C2 may output the transmission signals TX to the second electrodes 220 of the sensor layer 200, and the input detecting circuit 200C3 may receive the sensing signals RX from the first electrodes 210.

The input detecting circuit 200C3 may convert an analog signal into a digital signal. For example, the input detecting circuit 200C3 amplifies the received analog signal and then filters it. That is, the input detecting circuit 200C3 may convert the filtered signal into the digital signal. The sensor driver 200C may provide the coordinate signal I-SS to the main driver 1000C.

FIG. 7B illustrates an interface system IFD (see FIG. 3A), according to an embodiment of the present disclosure.

Referring to FIGS. 6 and 7B, the main driver 1000C may control the sensor driver 200C such that the sensor driver 200C operates in the second mode MD2. For example, the main driver 1000C may transmit a first control signal O-CS1 to the sensor driver 200C and transmit a second control signal O-SC2 to the object OB. For example, the first control signal O-CS1 and the second control signal O-SC2 may include determined (or predetermined) protocol information. The first control signal O-CS1 may include an encoding algorithm (or encoding information), and the second control signal O-SC2 may include a decoding algorithm (or decoding information).

The sensor driver 200C may perform an encoding algorithm including position information of the first electrodes 210 and the second electrodes 220 based on the first control signal O-CS1. Then, the sensor driver 200C may output the signal O-TX generated based on the encoding algorithm to the sensor layer 200. For example, a first digital code in a time domain may be generated based on an encoding algorithm, and the first digital code may be modulated to generate the signal O-TX. That is, the signal O-TX may be an analog signal.

The object OB may include a receiver 310, a decoder 320, and a communicating unit 330.

The receiver 310 may include the sensing electrode 310-E, an amplifier, and an analog-to-digital converter. A capacitor is formed between the sensing electrode 310-E and the first electrodes 210 and the second electrodes 220 of sensor layer 200, and the object OB may receive signal O-TX via the sensing electrode 310-E. The receiver 310 may convert the signal O- TX into a second digital code in the time domain via the amplifier and the analog-to-digital converter.

The decoder 320 may decode the second digital code to restore the position information of the electrodes in the sensor layer 200. The communicating unit 330 may transmit the output signal O-RX including the position information to the main driver 1000C.

According to an embodiment of the present disclosure, a driving method for reducing the number of the first digital codes and the number of the second digital codes is described below. According to the driving method, the time required to simultaneously drive all channels may be reduced without reducing the accuracy of the position information of the object OB in the sensor layer 200. Thus, an interface system (IFD) that may be driven at high speed may be provided even when the size of the electronic device 1000 is increased. The all channels may include first electrodes 210 and second electrodes 220.

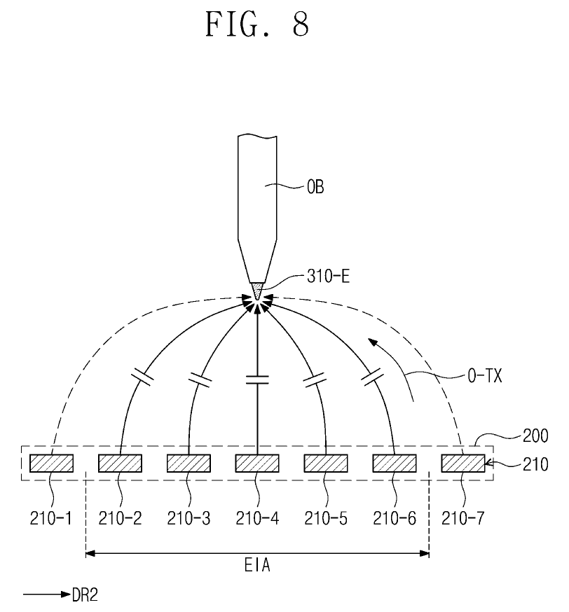

FIG. 8 is a diagram illustrating an interface system (IFD, see FIG. 3A), according to an embodiment of the present disclosure.

Referring to FIGS. 7B and 8, seven first electrodes 210 included in the sensor layer 200, and an object OB are illustratively shown. The object OB may receive a signal O-TX from the first electrodes 210.

At the object OB, a strength of a signal received from the first electrodes 210-1, 210-7 disposed outside an effective impedance area EIA may be very small compared to a signal received from five first electrodes 210-2, 210-3, 210-4, 210-5, 210-6 disposed within the effective impedance area EIA. Although FIG. 8 illustrates that five first electrodes 210-2, 210-3, 210-4, 210-5, and 210-6 are included in the effective impedance area EIA, the present disclosure is not limited thereto.

According to an embodiment of the present disclosure, the digital code, serving as the basis of the signal O-TX, may be divided into two or more groups considering the effective impedance area EIA. In this case, an order of a matrix for generating the code included in each of the groups may be reduced. As the order of the matrix is reduced, a power consumption of the sensor driver 200C that generates the signal O-TX may be reduced and a transmission time for transmitting the signal O-TC may be reduced.

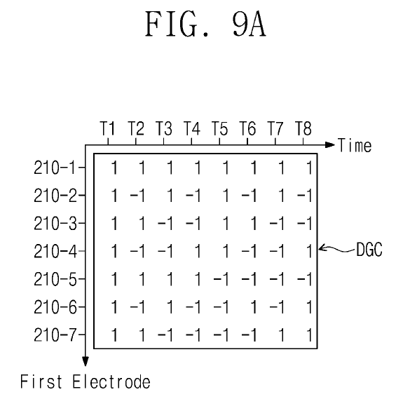

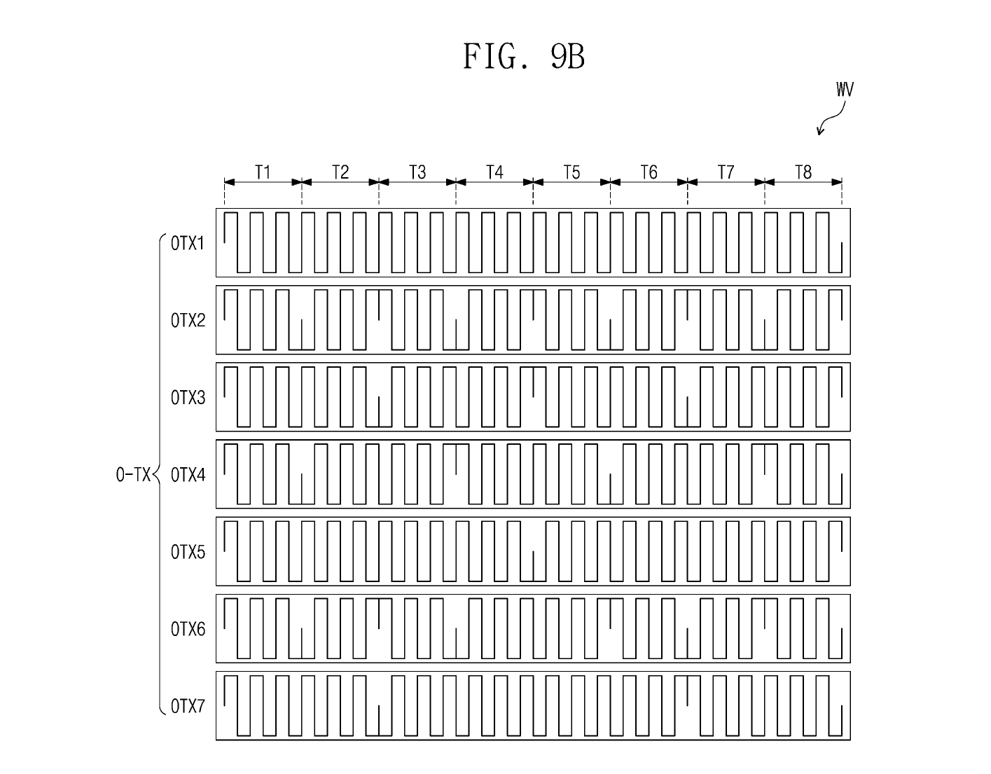

FIG. 9A illustrates a digital code (DGC), according to an embodiment of the present disclosure. FIG. 9B is a waveform diagram showing the signal O-TX, according to the digital code DGC shown in FIG. 9A.

Referring to FIGS. 8 and 9A, a digital code (DGC) in the time domain is shown. A horizontal axis in FIG. 9A represents time, and a vertical axis in FIG. 9A may correspond to the first electrodes 210-1, 210-2, 210-3, 210-4, 210-5, 210-6, and 210-7 arranged along the second direction DR2. The digital code (DGC) may be a Hammad code, the present disclosure is not limited thereto. For example, the digital code (DGC) may be transformed into various codes of orthogonal codes.

FIG. 9B illustrates voltage waveforms WV of signals OTX1, OTX2, OTX3, OTX4, OTX5, OTX6, and OTX7 provided to the first electrodes 210-1, 210-2, 210-3, 210-4, 210-5, 210-6, and 210-7 corresponding to the first to eighth time periods T1, T2, T3, T4, T5, T6, T7, and T8.

Although an example that ‘1’ of the digital code DGC is binary-phase-modulated as a phase of 0 degrees and ‘-1’ of the digital code DGC is binary-phase-modulated as a phase of 180 degrees is illustrated in FIG. 9B, this is merely an example embodiment and the present disclosure is not limited thereto. For example, a digital code (DGC) may be modulated with various modulation techniques such as a phase modulation, a frequency modulation, or an amplitude modulation, or with a combination of two or more modulation techniques.

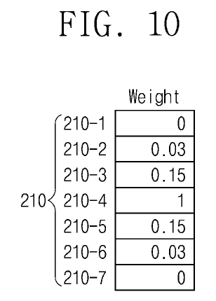

FIG. 10 is a diagram describing a weight coefficient determined between the first electrodes 210 and the object OB (see FIG. 8), according to an embodiment of the present disclosure.

Referring to FIGS. 8 and 10, the weight coefficient may be changed by impedances between the first electrodes 210 and the sensing electrode 310-E of the object OB. The weight coefficient of the 4-th first electrode 210-4 facing the sensing electrode 310-E of the object OB is the largest, and the weight coefficients of the 1-st first electrode 210-1 and the 7-th first electrode 210-7 located outside the effective impedance area EIA may be 0.

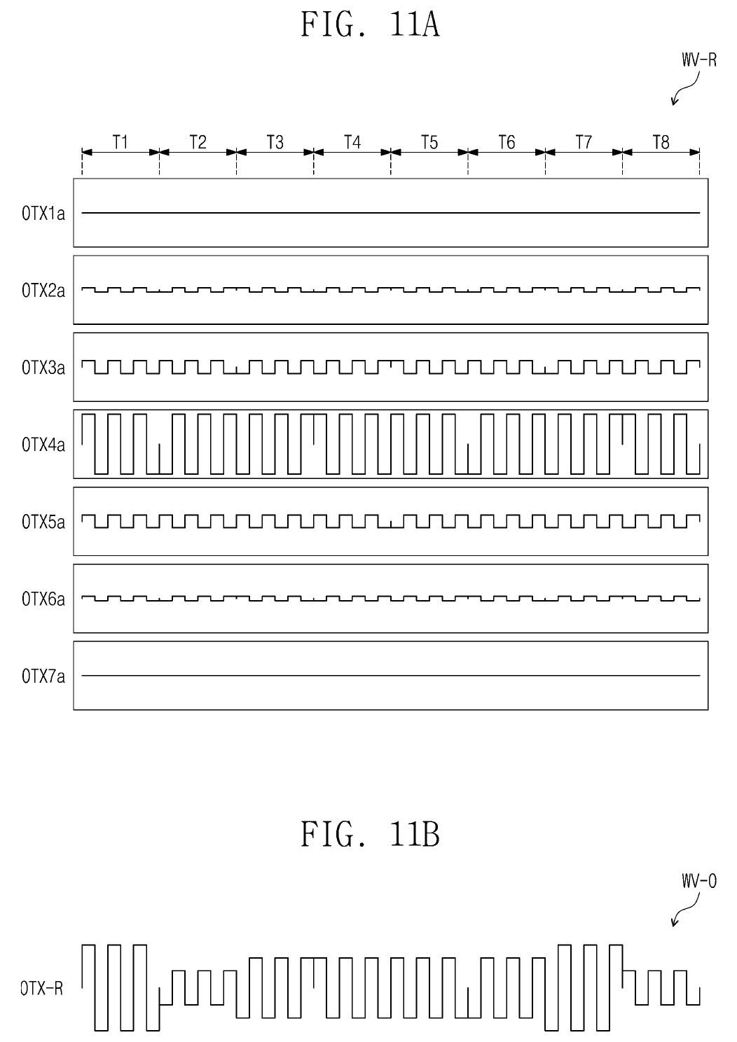

FIG. 11A shows voltage waveforms WV-R of signals OTX1a, OTX2a, OTX3a, OTX4a, OTX5a, OTX6a, and OTX7a received at an object OB (see FIG. 8). FIG. 11B shows a voltage waveform WV-O of a superimposed signal OTX-R, in which signals OTX1a, OTX2a, OTX3a, OTX4a, OTX5a, OTX6a, and OTX7a are superimposed.

Referring to FIGS. 9B, 10, 11A, and 11B, the voltage waveforms WV, which is transmitted in a form illustrated in FIG. 9B from the sensor layer 200, may be received at the object OB as the voltage waveforms (WV-R) whose amplitudes (or intensities) are adjusted by reflecting the weight of FIG. 10 as illustrated in FIG. 11A. That is, the object OB may receive the voltage waveform WV-O in which the voltage waveforms WV-R shown in FIG. 11A are all superimposed. The object OB may decode the voltage waveform WV-O to sense positional information of the object OB in the sensor layer 200.

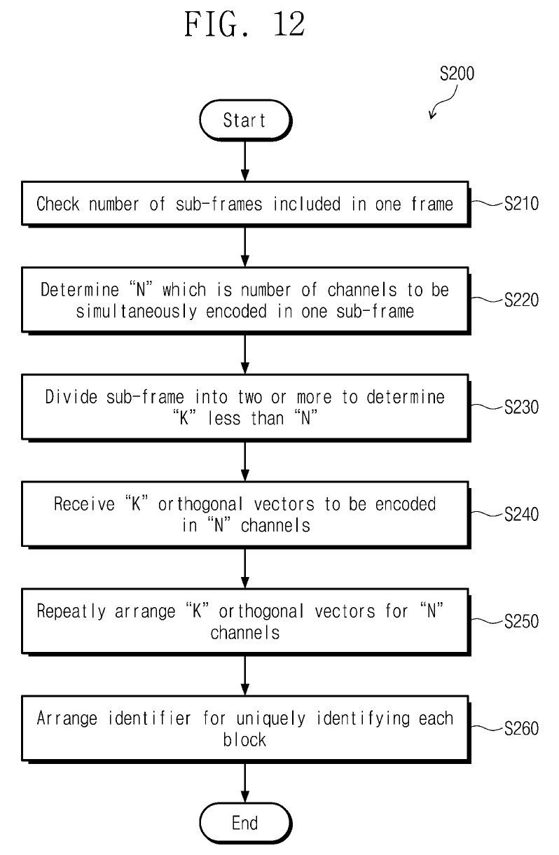

FIG. 12 is a flowchart illustrating an operation for dividing a digital code, serving as the basis of a signal O-TX (see FIG. 7B), into two or more groups, according to an embodiment of the present disclosure.

Referring to FIGS. 7B and 12, in the second mode MD2, the sensor driver 200C may check the number of sub-frames included in one frame (S210). The sensor driver 200C may determine “N” which is the number of channels to be simultaneously encoded in one sub-frame (S220). The sensor driver 200C may divide the one sub-frame into two or more to determine “K” less than “N” (S230). “N” may be an integer equal to or greater than 2, “K” may be an integral equal to or greater than 1 and less than “N”.

The sensor driver 200C may receive “K” orthogonal vectors to be encoded in “N” channels (S240). The sensor driver 200C may repeatedly arrange K orthogonal vectors for “N” channels (S250). The sensor driver 200C may arrange an identifier for uniquely identifying each block (S260).

Although it is described that the operations described in FIG. 12 are performed by the sensor driver 200C as an example, the present disclosure is not limited thereto. For example, the operations described in FIG. 12 may be performed in the main driver 1000C, or may be performed in a separate driver implemented in a chip different from the main driver 1000C and the sensor driver 200C.

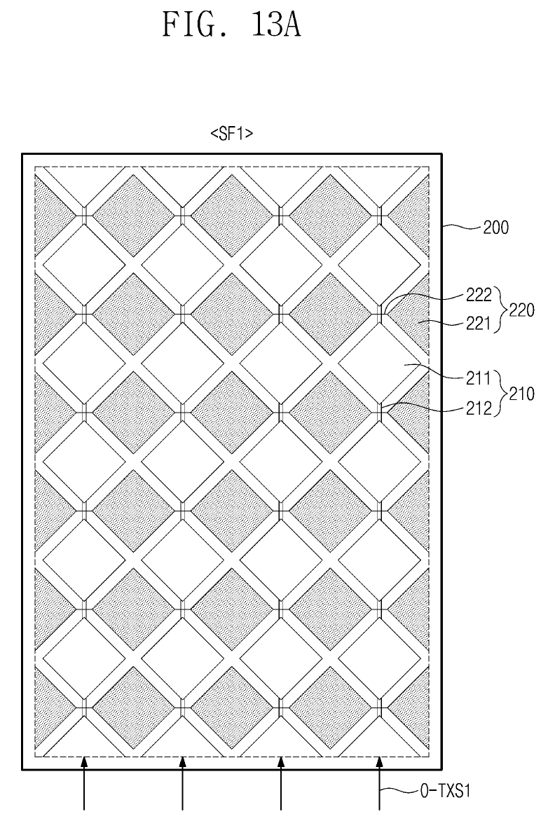

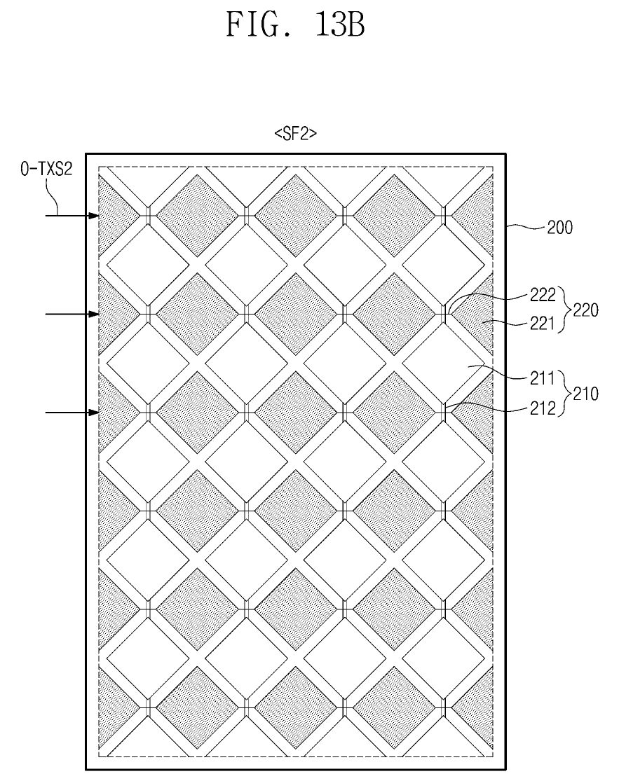

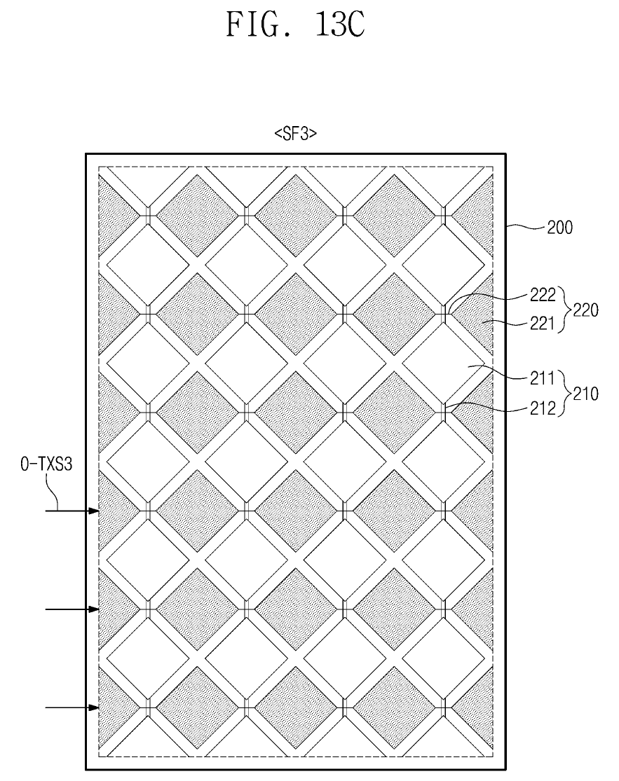

Below, each step described in FIG. 12 is described in more detail through FIGS. 13A-16C.

FIG. 13A is a diagram illustrating a signal O-TXS1 received by the sensor layer 200 in the first sub-frame SF1, according to an embodiment of the present disclosure. FIG. 13B is a diagram illustrating a signal O-TXS2 received by the sensor layer 200 in the second sub-frame SF2, according to an embodiment of the present disclosure. FIG. 13C is a diagram illustrating a signal O-TXS3 received by the sensor layer 200 in the third sub-frame SF3, according to an embodiment of the present disclosure.

Referring to FIGS. 7B, 12, 13A, 13B, and 13C, in the second mode MD2, the sensor driver 200C may check the number of sub-frames included in one frame (S210). For example, one frame may be defined in which a signal is provided to each of the first electrodes 210 and the second electrodes 220 included in the sensor layer 200 at least once.

FIGS. 13A-13C illustrate an example in which the number of sub-frames SF1, SF2, and SF3 included in one frame is three. In the first sub-frame SF1, the sensor driver 200C may output signals O-TXS1 to all of the first electrodes 210 of the sensor layer 200. In the second sub-frame SF2 consecutive to the first sub-frame SF1, the sensor drive 200C may output signals O-TXS2 to a part of the second electrodes 220 of the sensor layer 200. In the third sub-frame SF3 consecutive to the second sub-frame SF2, the sensor drive 200C may output signals O-TXS3 to other part of the second electrodes 220 of the sensor layer 200.

According to an embodiment of the present disclosure, the sensor layer 200 does not receive signals provided from the object OB. Thus, the operation of the first to third sub-frames SF1, SF2, SF3 may be continuous.

Although it is described in FIGS. 13A-13C that one frame is divided into three sub-frames SF1, SF2, and SF3 and operates as an example, the present disclosure is not limited thereto. For example, one frame is not divided into sub-frames, and the sensor driver 200C may output a signal to the first electrodes 210 and the second electrodes 220 at the same time. Alternatively, one frame may be divided into two sub-frames. Alternatively, one frame may be divided into three or more sub-frames.

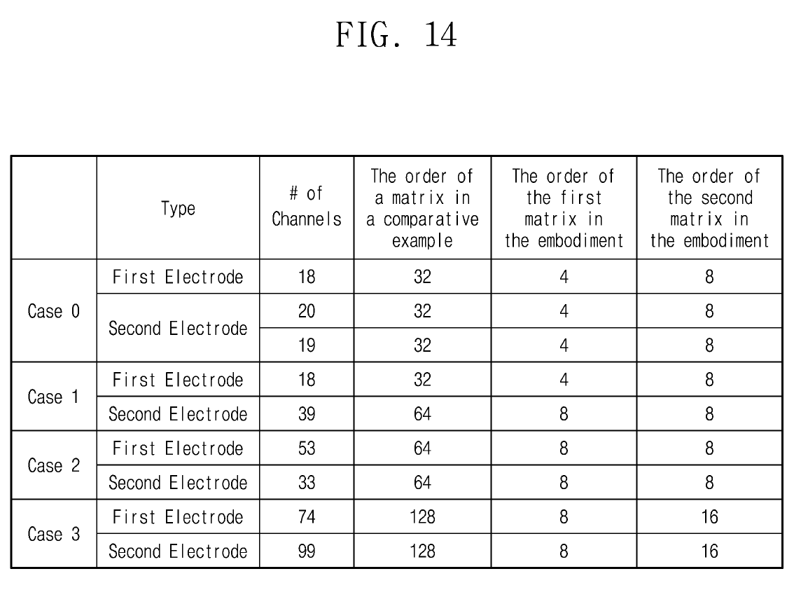

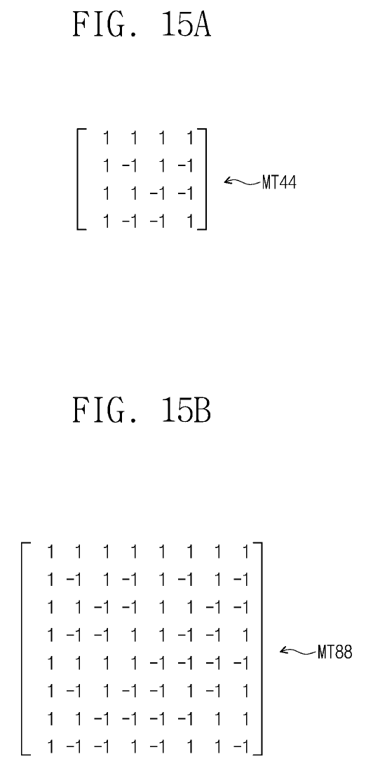

FIG. 14 is a table illustrating a determination example of an order of a first matrix and an order of a second matrix for each case, according to an embodiment of the present disclosure. FIG. 15A illustrates a 4×4 matrix MT44, according to an embodiment of the present disclosure. FIG. 15B illustrates an 8×8 matrix MT88, according to an embodiment of the present disclosure.

Referring to FIGS. 7B, 12, and 14, the sensor driver 200C may determine “N” which is the number of channels to be simultaneously encoded in one sub-frame (S220).

Referring to Case 0 and Case 1, the number of the first electrodes 210 may be 18, and the number of the second electrodes 220 may be 39. The number of first electrodes 210 may correspond to the number of channels of the first electrodes 210, and the number of second electrodes 220 may correspond to the channel number of the second electrodes 220. In the Case 0, one frame may include three sub-frames, as described above in FIGS. 13A-13C. In the Case 1, one frame may include two sub-frames.

Referring to the Case 2, the number of the first electrodes 210 may be 53, and the number of the second electrodes 220 may be 33. Referring to the Case 3, the number of the first electrodes 210 may be 74, and the number of the second electrodes 220 may be 99.

The order of the matrix described in the table may mean the number of rows of the square matrix. For example, in the Case 0, the order of the matrix for the first electrode, according to the comparative example is described as 32, which may mean that a 32×32 matrix is used for signal transmission. In addition, in the Case 0, the order of the first matrix for the first electrode, according to the embodiment is described as 4, which may mean that a 4×4 matrix is used for a transmission of a first signal, which will be described later. In the Case 1, the order of the second matrix for the first electrode, according to the embodiment is described as 8, which may mean that an 8×8 matrix is used for a transmission of a second signal, which will be described later.

Below, the Case 0 is specifically described, and the content described below may also be applied to various cases described in the table. In addition, the present disclosure may be applied to various cases other than the cases described in FIG. 14.

Referring to the Case 0, the number of channels to be simultaneously encoded in the first sub-frame may be “18”, the number of the channels to be simultaneously encoded in the second sub-frame may also be “20”, and the number of channels to be simultaneously encoded in the third sub-frame may further be “19”. The number of channels to be encoded may correspond to the number of electrodes.

The sensor driver 200C may divide the sub-frame into two or more to determine “K” less than “N” (S230). In one embodiment of the present disclosure, “K” may be determined as the number greater than the number of channels placed within the effective impedance area (EIA, see FIG. 8). In the effective impedance area EIA (see FIG. 8) described above in FIG. 8, five first electrodes 210 may be placed, and thus “K” may be selected from values greater than 5and less than “N”. Hereinafter, a case where the value of “K” is determined to be “8” will be described as an example.

Referring to FIGS. 7B, 12, and 15B, the sensor driver 200C may receive “K” orthogonal vectors to be encoded in “N” channels (S240). As described above, when the value of “K” is determined to be “8”, the sensor driver 200C may obtain the “K” orthogonal vectors from the 8×8 matrix MT88. The 8×8 matrix MT88 may be, but is not limited to, a Hadamard matrix. The sensor driver 200C may obtain eight orthogonal vectors by using the 8×8 matrix MT88. The 8×8 matrix MT88 may correspond to the second matrix as a signal for distinguishing channels in a block of the sensor layer 200. The number of rows of the second matrix may be equal to or greater than the number of electrodes included in one block. The channels in the block may correspond to the first electrodes 210 in the case of a first sub-frame.

The sensor driver 200C may arrange an identifier for uniquely identifying each block (S260). For example, the number of channels to be simultaneously encoded in the first sub-frame is “18”, which is divided by the value of “K” to be 2.25. In this case, three identifiers that are integers equal to or greater than 2.25 are needed. The number of channels to be simultaneously encoded in the second sub-frame is “20”, which is divided by the “K” value to be 2.5. In this case, three identifiers that are integers equal to or greater than 2.5 are needed. The number of channels to be simultaneously encoded in the third sub-frame is “19”, which is divided by the “K” value to be 2.375. In this case, three identifiers that are integers equal to or greater than 2.375 are needed.

Referring to FIGS. 7B, 12, 14, and 15A, a minimum size of a matrix among matrices, which have rows and columns that are powers of 2 and include three identifiers, is a 4×4 matrix MT44. Accordingly, the sensor driver 200C may arrange an identifier for each block by using the 4×4 matrix MT44. The 4×4 matrix MT44 may correspond to the first matrix as a signal for distinguishing blocks.

The case where the number of channels of the first electrodes 210 in the Case 0 is 18 will be described as an example. As in the comparative example of the present disclosure, if a signal for distinguishing 18 channels is transmitted by a Hamadad code without dividing one sub-frame, the minimum size of a matrix among matrices, which have rows and columns that are powers of 2 and include 18 identifiers, is a 32×32 matrix. Therefore, 32 codes have to be transmitted on respective channels during one sub-frame. However, as the present disclosure, if codes is transmitted with a combination matrix of a first matrix including an identifier and a second matrix for distinguishing channels during one sub-frame, a 4×4 matrix and an 8×8 matrix may be used. Thus, 12 codes may be transmitted on each of the channels during one sub-frame.

When the number of channels of the first electrodes 210 is 18 in the Case 0, a size of a matrix having 18 or more rows and columns that are powers of 2 may be referred to as a reference matrix. This may correspond to the matrix, according to the comparative example described in FIG. 14. According to an embodiment of the present disclosure, the first matrix and the second matrix may have a smaller size than the reference matrix. That is, in the operation of providing a signal to the first electrode in the Case 0, the 32×32 matrix may correspond to the reference matrix, the first matrix may be a 4×4 matrix, and the second matrix may be an 8×8 matrix. The number of rows of the reference matrix may correspond to the product of the number of rows in the first matrix and the number of rows in the second matrix. Alternatively, the number of columns of the reference matrix may correspond to a product of the number of columns of the first matrix and the number of columns in the second matrix.

For each case, according to the comparative example, total sums of the orders of the matrices described in the table are followings: the Case 0 is 96, the Case 1 is 96, the Case 2 is 128, and the Case 3 is 256. The length and the transmission time of the signal may be proportional to the total sum of the orders of the matrix. That is, as the number of the first and second electrodes 210 and 220 included in the sensor layer 200 increases, that is, the the sensor layer 200 becomes larger, the signal transmission time may become longer. The total sum of the orders of the matrices for each case in table, according to the embodiments of the present disclosure is 36 for the Case 0, 28 for the Case 1, 32 for the Case 2, and 48 for the Case 3. That is, even if the size of the sensor layer 200 is larger than that in the comparative example, the signal transmission time may not increase significantly. Rather, the transmission time of the Case 3 including the largest number may be shorter than the transmission time of the Case 0, according to the comparative example.

According to an embodiment of the present disclosure, since the size of the code serving as the basis of the signal O-TX (refer to FIG. 7B) is reduced, a speed of the sensor driver 200C (refer to FIGS. 7B) that generates the signal O-TC may be increased, and the transmission time of the signal O-CT may also be shortened. Therefore, the operation of the second mode (MD2, refer to FIG. 7B) may be speeded up. Thus, a system capable of high-speed driving may be implemented even if the size (or area) of the sensor layer 200 is increased.

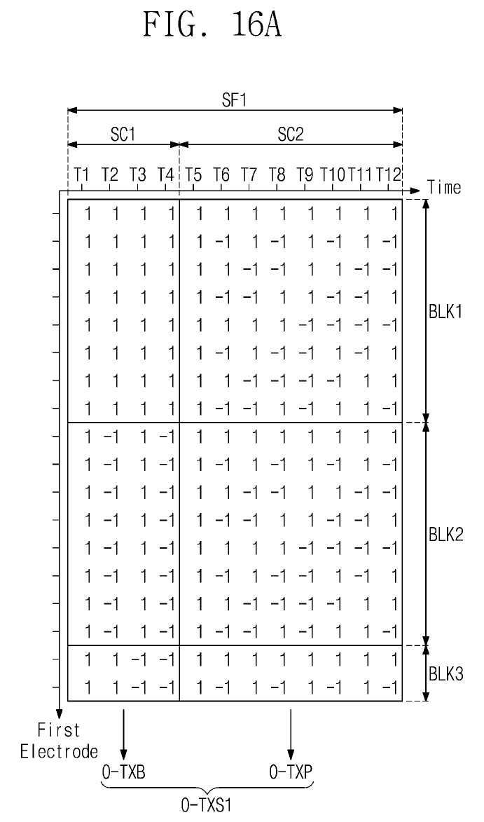

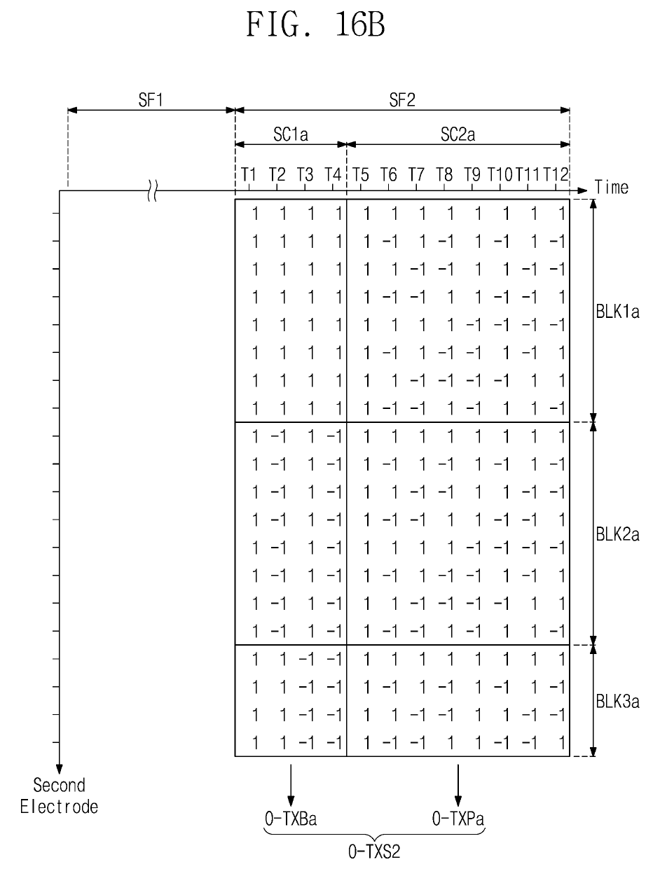

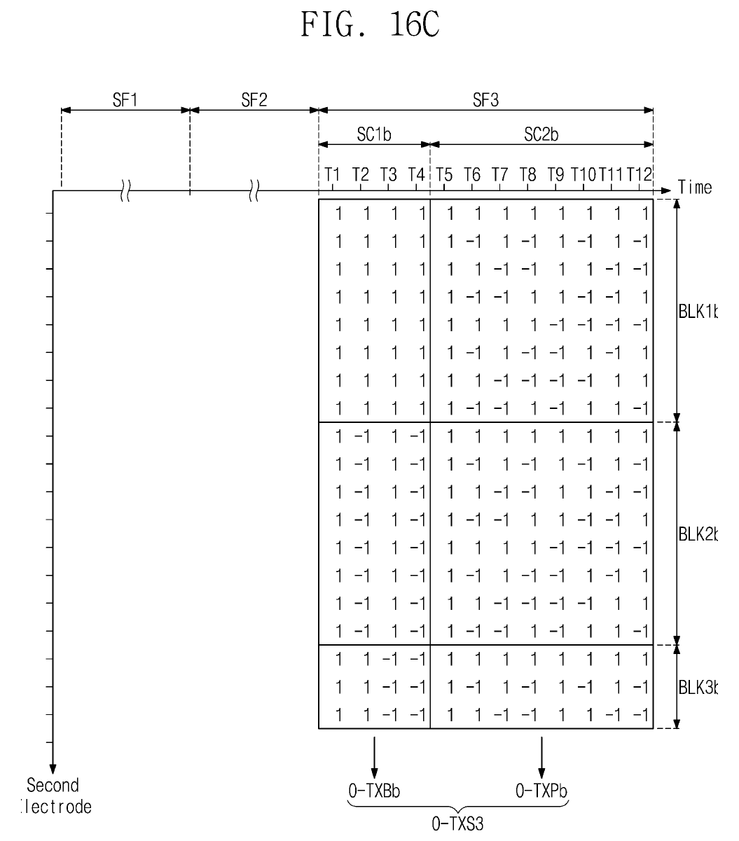

FIG. 16A is a diagram illustrating a code corresponding to a signal received by a sensor layer in one sub-frame, according to an embodiment of the present disclosure. FIG. 16B is a diagram illustrating a code corresponding to a signal received by a sensor layer in one sub-frame, according to an embodiment of the present disclosure. FIG. 16C is a diagram illustrating a code corresponding to a signal received by a sensor layer in one sub-frame, according to an embodiment of the present disclosure.

Referring to FIGS. 7B, 12, 14, and 16A, the number of channels to be encode in the first sub-frame SF1, that is, the number of the first electrodes 210, is 18. The first sub-frame SF1 may be divided into a first period SC1 and a second period SC2. The first period SC1 and the second period SC2 may be referred to as a first section SC1 and a second section SC2, respectively.

The first period SC1 may be a period in which the first signal O-TXB for distinguishing the blocks BLK1, BLK2, and BLK3 is transmitted, and the second period SC2 may be a period where the second signal O-TXP for distinguishing the channels in the block BLK1, BLK2, or BLK3 is transmitted. The signal O-TXS1 of the first sub-frame SF1 may include a first signal O-TXB and a second signal O-TXP. The length of the first period SC1 in which the first signal O-TXB is output may be equal to or less than the length of the second period SC2 in which the second signal O-TXP is output.

Each of the first signal O-TXB and the second signal O-TXP may be an analog signal generated by modulating the code illustrated in FIG. 16A. This may be understood through the content described with reference to FIGS. 9A and 9B.

Referring to FIG. 16B, the number of channels to be encoded in the second sub-frame SF2, that is, the number of second electrodes 220, is 20. The second sub-frame SF2 may be divided into a first period SC1a and a second period SC2a. The first period SC1a may be a period in which a first signal O-TXBa for distinguishing the blocks BLK1a, BLK2a, and BLK3a is transmitted, and a second period SC2a may be a period in which the second signal O-TXPa for distinguishing the channels in the block BLK1a, BLK2a, or BLK3a is transmitted. The signal O- TXS2 in the second sub-frame SF2 may include the first signal O-TXBa and the second signal O-TXPa.

Referring to FIG. 16C, the number of channels to be encoded in the third sub-frame SF3, that is, the number of second electrodes 220, is 19. The third sub-frame SF3 may be divided into a first period SC1b and a second period SC2b. The first period SC1b may be a period in which a first signal O-TXBb for distinguishing the blocks BLK1b, BLK2b, and BLK3b is transmitted, and the second period SC2b may be a period in which a second signal O-TXPb for distinguishing channels in the block BLK1b, BLK2b, or BLK3b is transmitted. The signal O-TXS3 in the third sub-frame SF3 may include the first signal O-TXBb and the second signal O-TXPb.

In FIGS. 16A-16C, it is described that the first period SC1, SC1a, or SC1b is preceded by the second period SC2, SC2a, or SC2b, but the present disclosure is not limited thereto. For example, signals generated based on a code included in the second period SC2, SC2a, or SC2b may be output first, and then signals generated based on the code included in the first period SC1, SC1a, or SC1b may be output later.

To be specific based on the first sub-frame SF1, the first electrodes 210 may be divided into blocks BLK1, BLK2, and BLK3, each of which includes up to eight channels. Referring to FIG. 16A, the first block BLK1 may include eight channels (corresponding to eight first electrodes), the second block BLK2 may include eight channels (corresponding to eight first electrodes), and the third block BLK3 may include two channels (corresponds to two first electrodes). An identifier for distinguishing the first to third blocks BLK1, BLK2, and BLK3 may be generated by using the 4×4 matrix MT44.

A signal provided to the first block BLK1 in the first period SC1 may be a signal generated based on a code in which values (1, 1, 1, 1) of a first row of the 4×4 matrix MT44 are repeated, a signal provided to the second block BLK2 may be a signal produced based on a code that values (1, −1, 1, −1) of a second row of the 4×4 matrix MT44 are repeated, and a signal provided to a third block BLK3 may be a signal that is generated based on a coding that values (1, 1, −1, −1) of a third row of the 4×4 matrix MT44 are repeated. That is, codes corresponding to the first signals respectively provided to the electrodes included in one block during the first period SC1 may be the same as each other.

A signal generated based on the values (or code) of the 8×8 matrix MT88 may be provided to each of the first to third blocks BLK1, BLK2, and BLK3 in the second period SC2. The sensor driver 200C may repeatedly arrange eight orthogonal vectors for eight channels. The eight orthogonal vectors in the first eight channels may correspond to a first block BLK1, the eight orthonormal vectors in the second eight channels may correspond to the second block BLK2, and the two orthogonal vectors in the third two channels may correspond to the third block BLK3. That is, codes corresponding to the second signals respectively provided to the electrodes included in one block during the second period SC2 may be different from each other.

The sensor layer 200 may output, during the first sub-frame SF1, signals corresponding to 12 codes for each channel corresponding to the first to twelfth time periods T1, T2, T3, T4, T5, T6, T7, T8, T9, T10, T11, and T12. The object OB may receive and decode the signals to determine the position of the corresponding block and the position of the channel within the block.

As described above with reference to FIGS. 8-11A, the object OB (see FIG. 8) may not receive a signal from electrodes placed outside the effective impedance area EIA (see FIG. 9), or a strength of the received signal may be very weak. According to an embodiment of the present disclosure, the object OB receives the signal generated from the code of the first period SC1 to determine the block in the sensor layer 200 where the object OB is located. In addition, the object OB receives a signal generated from the code of the second period SC2 and determines the position of the electrode in the block where the object OB is located. Thus, the object OB may restore the position information based on the signal provided from the electrodes that provide a valid signal in the block. Thus, the accuracy of the position information of the object OB in the sensor layer 200 may not be reduced.

Referring to FIG. 14, when a signal for distinguishing a channel is transmitted without dividing each of the first to third sub-frames SF1, SF2, SF3 in the Case 0 as in the comparative example of the present disclosure, it is necessary to output a signal corresponding to a total of 96 codes during one frame. According to an embodiment of the present disclosure, as each of the first to third sub-frames SF1, SF2, and SF3 is divided, signals corresponding to a total of 36 codes may be output. Therefore, since the size of the code serving as the basis of the signal O-TX (see FIG. 7B) is reduced, the speed of the sensor driver 200C (see FIG. 6B) generating the signal O-TC may increase, and the transmission time of the signal O-CT may be shortened. Therefore, the operation of the second mode (MD2, refer to FIG. 7B) may be speeded up. Further, as the length of the signal O-TX is reduced, the power consumption of the sensor driver 200C generating the signal may also be reduced.

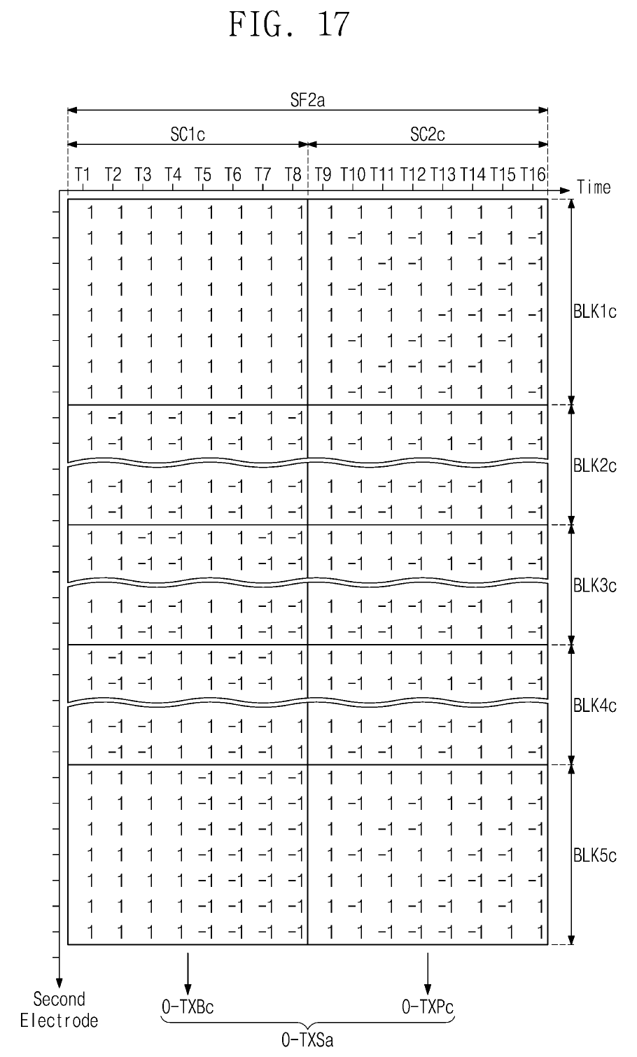

FIG. 17 is a diagram illustrating a code corresponding to a signal received by a sensor layer in one sub-frame, according to an embodiment of the present disclosure.

Referring to FIGS. 7B, 12, 14, and 17, in the Case 1, a signal may be output to eighteen (18) first electrodes 210 in the first sub-frame, and a signal may be input to thirty-nine (39) second electrodes 220 in the second sub-frame SF2a.

The number of channels to be simultaneously encoded in the second sub-frame SF2a shown in FIG. 17 may be “39”. One of the numbers greater than the number of channels placed within the effective impedance area EIA (see FIG. 8) may be determined as the “K” value. For example, the “K” value may be determined as “8”.

The number of channels is then divided by the determined “K” value to determine an identifier for uniquely identifying each block. Dividing 39 by 8 gives 4.875. In this case, five identifiers that are integers equal to or greater than 4.875 are needed. The minimum size of a matrix among matrices having rows and columns that are powers of 2 and including five identifiers is an 8×8 matrix (MT88, see FIG. 15B). Accordingly, the sensor driver 200C may arrange an identifier for each block by using the 8×8 matrix MT88.

The number of channels to be encoded in the second sub-frame SF2a, that is, the number of second electrodes 220, is 39. The second sub-frame SF2a may be divided into a first period SC1c and a second peirod SC2c. The first period SC1c may be a period in which a first signal O-TXBc for distinguishing blocks is transmitted, and the second period SC2c may be a range in which a second signal O-TXPc for distinguishing channels in a block is transmitted.

The second electrodes 220 may be divided into first to fifth blocks BLK1c, BLK2c, BLK3c, BLK4c, and BLK5c, each of which includes up to eight channels. Each of the first to fourth blocks BLK1c, BLK2c, BLK3c, and BLK4c may include eight channels, and the fifth block BLK5c may include seven channels. An identifier for distinguishing the first to fifth blocks BLK1c, BLK2c, BLK3c, BLK4c, and BLK5c may be generated by using an 8×8 matrix MT88.

In the first period SC1c, the first signal O-TXBc provided to the first block BLK1c may be a signal generated based on a code in which values (1, 1, 1, 1, 1, 1, 1, 1) of a first row of the 8×8 matrix MT88 are repeated, the first signal 0-TXBc provided to the second block BLK2c may be a signal generated based on a code in which values (1, −1, 1, −1, 1, −1, 1, −1) of a second row of the 8×8 matrix MT88 are repeated, the first signal O-TXBc provided to the third block BLK3c may be a signal generated based on a code in which the values (1, 1, −1, −1, 1, 1, −1, −1) of a third row of the 8×8 matrix MT88 are repeated. The first signal O-TXBc provided to a fourth block BLK4c may be a signal generated based on a code in which values (1, −1, −1, 1, 1, −1, −1, 1) of a fourth rows of 8×8 matrices MT88 are repeated, and the first signal O-TXBc provided to a fifth block BLK5c may be a signal generated based on a code in which values (s) (1, 1, 1, 1, −1, −1, −1. −1) of a fifth row of the 8×8 matrix MT88 are repeated.

In the second period SC2, the second signal O-TXPc including the code of the 8×8 matrix MT88 may be provided to each of the first to fifth blocks BLK1c, BLK2c, BLK3c, BLK4c, and BLK5c.

In the second sub-frame SF2a, the sensor layer 200 may correspond to the first to 16th time periods T1, T2, T3, T4, T5, T6, T7, T8, T9, T10, T11, T12, T13, T13, T14, T15, and T16 to output signals corresponding to 16 codes for each channel. The object OB may receive and decode the first signal O-TXBc and the second signal O-TXPc to determine a position of a corresponding block and a position of a channel within the block.

As to the comparative example of the present disclosure, if a signal for distinguishing 39 channels is transmitted with a Hammad code without dividing one sub-frame, the minimum size of the matrix among matrices, having rows and columns that are powers of 2 and including 39 identifiers, is a 64×64 matrix. Therefore, it is necessary to transmit a signal generated based on 64 codes for respective channels during one sub-frame. However, as the present disclosure, if codes are transmitted with a combination matrix of a first matrix including an identifier and a second matrix for distinguishing channels during one sub-frame, an 8×8 matrix and an 8×8 matrix may be used. Therefore, a signal generated based on 16 codes may be transmitted on respective channels during one sub-frame.

According to an embodiment of the present disclosure, since the size of the code serving as the basis of the signal O-TXSa is reduced, the speed of the sensor driver 200C (see FIG. 7B) generating the signal O-TXSa may improve, and the transmission time of the signal O-TXSa may be shortened. Therefore, the operation of the second mode (MD2, refer to FIG. 7B) may be speeded up. Further, as the length of the signal O-TXSa is reduced, the power consumption of the sensor driver 200C generating the signal may also be reduced.

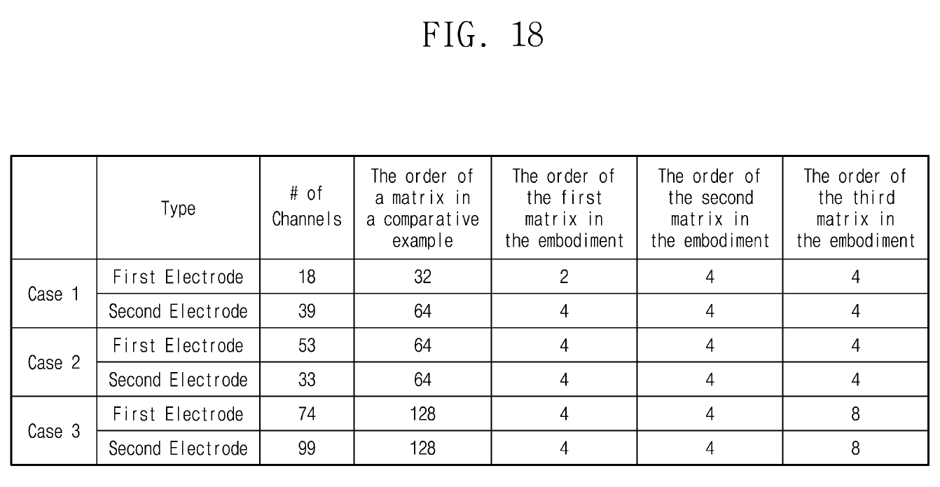

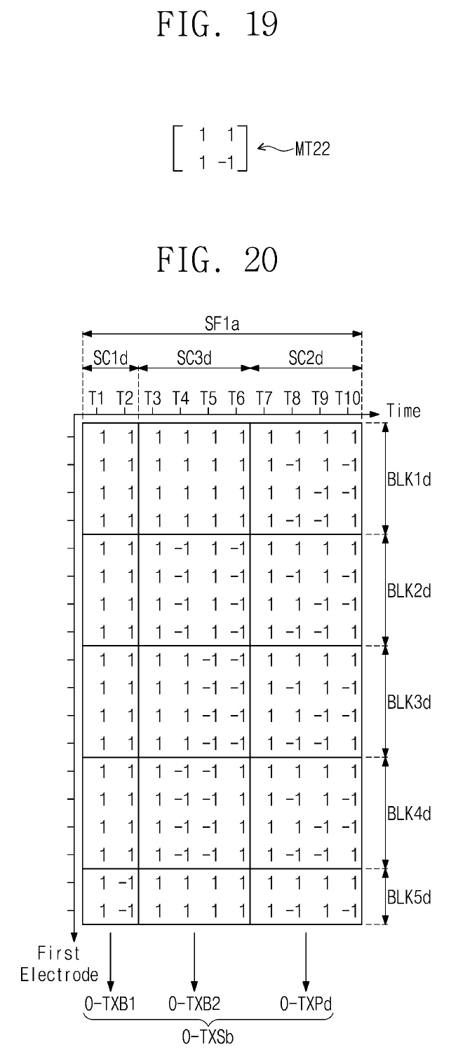

FIG. 18 is a table showing an example of determining an order of a first matrix, an order of a second matrix, and an order of a third matrix for each case, according to an embodiment of the present disclosure. FIG. 19 illustrates a 2×2 matrix MT22, according to an embodiment of the present disclosure. FIG. 20 is a diagram illustrating a code corresponding to a signal received by a sensor layer in one sub-frame, according to an embodiment of the present disclosure.

Referring to FIGS. 12, 18, 19, and 20, an example embodiment will be described in reference with the first electrode 210 of Case 0 and a signal provided to the first electrode 210. The number of channels to be simultaneously encoded in the first sub-frame may be “18”.

The sensor driver 200C may determine “K” less than “N” by dividing the sub-frame SF1a into two or more. The sensor driver 200C may receive “K” orthogonal vectors to be encoded in “N” channels. In an embodiment of the present disclosure, the sensor driver 200C may divide one sub-frame into three, and the value of “K” may be determined to be “4”, which is a value less than “N”. The sensor driver 200C may obtain four orthogonal vectors by using the 4×4 matrix MT44 (see FIG. 15A). The 4×4 matrix MT44 may correspond to the third matrix of FIG. 18 as a signal for distinguishing channels in a block.

The sensor driver 200C may arrange an identifier for uniquely identifying each block. For example, the number of channels to be simultaneously encoded in the first sub-frame is “18”, which is divided by the “K” value to be 4.5. In this case, five identifiers that are integers equal to or greater than 4.5 are needed. The minimum size of a matrix among matrices, having rows and columns that are powers of 2 and including five identifiers, is an 8×8 matrix MT88. The 8×8 matrix MT88 may be used to dispose an identifier for each block. Alternatively, a combination of matrices may be used to generate the five identifiers.

For example, five identifiers can be configured by using the 2×2 matrix MT22 and the 4×4 matrix MT44. The 2×2 matrix MT22 may correspond to the first matrix of FIG. 18, and the 4×4 matrix MT44 may correspond to the second matrix of FIG. 18.

In an embodiment of the present disclosure, one sub-frame SF1a may be divided into a first period SC1d, a second period SC2d, and a third period SC3d. Although FIG. 20 illustrates an example in which the first period SC1d, the third period SC3d, and the second period SC2d are sequentially arranged, the present disclosure is not limited thereto. The order of the first period SC1d, the third period SC3d, and the second period SC2d may be modified.

The first period SC1d may be a period in which the first signal O-TXB1 for distinguishing the blocks BLK1d, BLK2d, BLK3d, BLK4d, and BLK5d is transmitted, and the second period SC2d may be a period in which the second signal O-TXPd for distinguishing the channels in the block BLK1d, BLK2d, BLK3d, BLK4d, or BLK5d is transmitted. The third period SC3d may be a period in which the third signal O-TXB2 for distinguishing the blocks BLK1d, BLK2d, BLK3d, BLK4d, and BLK5d is transmitted. A length of the first period SC1d in which the first signal O-TXB1 is output may be equal to or shorter than a length of the second period SC2d in which the second signal O-TXPd is output, and a length of the third period SC3d in which the third signal O-TX B2 is output may be equal to or shorter than the length of the first period SC1d. In the first period SC1d, the first signals O-TXB1 provided to the first to fourth blocks BLK1d, BLK2d, BLK3d, and BLK4d are signals generated based on a code in which values (1, 1) of a first row of the 2×2 matrix MT22 are repeated, and the first signals O-TXB1 provided to the fifth block BLK5d are signals generated from a code in which values (1, −1) of a second row of the 2×2 matrix MT22 are repeated.

In the third period SC3, the third signal O-TXB2 provided to the first block BLK1d and the fifth block BLK5d is a signal generated based on a code in which values (1, 1, 1, 1) of a first row of the 4×4 matrix MT44 are repeated. The first block BLK1d and the fifth block BLK5d may be distinguished by a combination of the first signal O-TXB1 provided in the first period SC1d and the third signal O-TXB2 provided in the third period sc3d.

In the third period SC3d, the third signal O-TXB2 provided to the second block BLK2d may be a signal generated based on a code in which values (1, −1, 1, −1) of a second row of the 4×4 matrix MT44 are repeated, the third signal O-TXB2 provided to the third block BLK3d may be a signals generated based on a code in which values (1, 1, −1, −1) of a third row of the 4×4 matrix MT44 are repeated, and the third signal O-TXB2 provided to the fourth block BLK4d may be signals generated based on codes in which values (1, −1, −1, 1) of a fourth row of the 4×4 matrix MT44 are repeated.

As to the comparative example of the present disclosure, if a signal for distinguishing 18 channels is transmitted by a Hamadad code without dividing one sub-frame, the minimum size of a matrix among matrices, having rows and columns that are powers of 2 and including 18 identifiers, is a 32×32 matrix. Therefore, 32codes should be transmitted on each of channels during one sub-frame. However, as the present disclosure, as the present disclosure, if codes are transmitted with a combination matrix of a first matrix and a second matrix including an identifier and a third matrix for distinguishing channels during one sub-frame, a 2×2 matrix MT22, a 4×4 matrix MT44, and a 4×4 matrices MT44 may be used. Therefore, 10 codes may be transmitted on each of channels during one sub-frame.

According to an embodiment of the present disclosure, since the size of the code serving as the basis of the signal O-TXSb is reduced, the speed of the sensor driver 200C (see FIG. 7B) generating the signal O-TCSb may increase, and the transmission time of the signal O-TCSb may be shortened. Therefore, the operation of the second mode (MD2, refer to FIG. 7B) may be speeded up. Further, as the length of the signal O-TXSb is reduced, the power consumption of the sensor driver 200C that generates the signal may also be reduced.

According to the present disclosure, an output signal from the object is provided directly to the main drive without passing through the sensor layer. Thus, the output signal is not affected by noise caused in the sensor layer by the display layer. Furthermore, as the output signal is provided to the main driver, a speed may be improved compared to when it is transmitted to the main driver via the sensor layer. In addition, since a size of a code serving as the basis of the signal transmitted in the sensor layer is reduced, an operation speed of the sensor driver that generates the signal may be increased, and a transmission time of the signal may be shortened. Further, the object may determine the positions of the block of the sensor layer and the electrode in the block, in which the object is located. That is, the object may restore the position information based on the signal provided from the electrodes that provide the valid signal in the block. Thus, the accuracy of the position information in the sensor layer of the object may not decrease. Further, as the length of the signal is reduced, the power consumption of the sensor driver that generates the signal may also be reduced.

While embodiments of the present invention have been described above, it will be understood by those skilled in the art that various modifications and changes may be made to the present invention without departing from the spirit and scope of the present invention as set forth in the following claims.

Therefore, the technical scope of the present invention should not be limited to the content described in the detailed description of the specification, but should be determined by the claims.

What is claimed is:

1. An electronic device comprising:
a sensor layer including a plurality of electrodes;
a sensor driver outputting a signal to N electrodes of the plurality of electrodes, where N is an integer equal to or greater than 2; and
a main driver controlling an operation of the sensor driver,
wherein the sensor driver is configured to:
during a first period, output a first signal to the sensor layer for distinguishing the N electrodes into a plurality of blocks; and
during a second period different from the first period, output a second signal to the sensor layer for distinguishing electrodes in the plurality of blocks among the N electrodes.

2. The electronic device of claim 1, wherein each of the plurality of blocks includes two or more electrodes among the N electrodes.

3. The electronic device of claim 1, wherein the sensor driver is configured to generate the first signal and the second signal using a code being based on a first matrix and a second matrix having sizes smaller than a reference matrix, respectively, the reference matrix including rows and columns being equal to or greater than N, and being powers of 2.

4. The electronic device of claim 3, wherein the number of the rows of the reference matrix corresponds to a product of a number of rows of the first matrix and a number of rows of the second matrix.

5. The electronic device of claim 3, wherein codes corresponding to each of first signals provided to electrodes included in one block among the plurality of blocks during the first period are values of a first row of the first matrix, and
codes corresponding to each of first signals provided to electrodes included in another block of the plurality of blocks during the first period are values of a second row of the first matrix.

6. The electronic device of claim 3, wherein a number of rows of the second matrix is equal to or greater than a number of electrodes included one block among the plurality of blocks.

7. The electronic device of claim 1, wherein codes corresponding to first signals provided to electrodes included in one block of the plurality of blocks during the first period are a same code as each other.

8. The electronic device of claim 1, wherein codes corresponding to second signals provided to electrodes included in one block of the plurality of blocks during the second period are different from each other.

9. The electronic device of claim 1, wherein the plurality of electrodes includes a plurality of first electrodes and a plurality of second electrodes intersecting with the plurality of first electrodes, and
the sensor driver is configured to output signals to the plurality of first electrodes and the plurality of second electrodes during one frame.

10. The electronic device of claim 9, wherein the one frame includes a first sub-frame and a second sub-frame consecutive to the first sub-frame,
the sensor driver is configured to:
during the first sub-frame, output the first signal and the second signal to at least a portion of the plurality of first electrodes, and
during the second sub-frame, output the first signal and the second signal to at least a portion of the plurality of second electrodes.

11. The electronic device of claim 1, wherein a length of the first period in which the first signal is output is equal to or shorter than a length of the second period in which the second signal is output.

12. The electronic device of claim 1, wherein the sensor driver outputs a third signal for distinguishing the plurality of blocks during a third period different from the first period and the second period, and
the plurality of blocks is configured to be distinguished by a combination of the first signal and the third signal.

13. The electronic device of claim 12, wherein a length of the first period in which the first signal is output is equal to or shorter than a length of the second period in which the second signal is output, and
a length of the third period in which the third signal is output is equal to or shorter than a length of the first period.

14. The electronic device of claim 1, wherein the main driver receives an output signal including position information generated based on the signal provided by the sensor layer from an external object.

15. A method for driving an electronic device, the method comprising:
determining a number of a plurality of sub-frames included in one frame;
determining N, where N is an integer equal to or greater than 2, that is a number of channels to be simultaneously encoded in one sub-frame of the plurality of sub-frames;
determining K less than N, where K is an integer equal to or greater than 1, and dividing each of the plurality of sub-frames into two or more;
receiving K orthogonal vectors to be encoded in the channels;
iteratively disposing the K orthogonal vectors to the channels;
distinguishing the channels into a plurality of blocks, and disposing an identifier for uniquely identifying each of the plurality of blocks; and
outputting a signal generated with a code including the identifier and the K orthogonal vectors.

16. The method of claim 15, wherein each of the plurality of blocks includes K or fewer channels of the channels, and a same identifier is disposed for the channels included in one of the plurality of blocks.

17. The method of claim 15, wherein values of the K orthogonal vectors are different from each other.

18. An interface system comprising:
a display panel including a display layer for displaying an image and a sensor layer including a plurality of electrodes;
a display driver driving the display layer;
a sensor driver outputting a signal to N electrodes of the plurality of electrodes, where N is an integer equal to or greater than 2;
a main driver controlling operations of the display driver and the sensor driver; and
an object receiving a signal from the sensor layer and outputting an output signal including position information to the main driver based on the signal,
wherein the sensor driver is configured to output a first signal to the sensor layer for distinguishing the N electrodes into a plurality of blocks during a first period, and output a second signal to the sensor layer for distinguishing electrodes included in the plurality of blocks among the N electrodes during a second period different from the first period.

19. The interface system of claim 18, wherein the output signal is configured to be transmitted from the object to the main driver via a near field communication.

20. The interface system of claim 18, wherein the sensor driver is configured to generate the first signal and the second signal using a code being based on a first matrix and a second matrix having sizes smaller than a reference matrix, respectively, the reference matrix including rows and columns being equal to or greater than N, and being powers of 2,
a number of the rows of the reference matrix corresponds to a product of a number of rows in the first matrix and a number of rows in the second matrix,
codes corresponding to first signals provided to electrodes included in one of the plurality of blocks during the first period are the same as each other, and
codes corresponding to second signals provided to electrodes included in the one of the plurality of blocks during the second interval are different from each other.
